(19) United States
(12) Patent Application Publication
(10) Pub. No.: US 2023/0106451 A1
(43) Pub. Date: Apr. 6, 2023

(54) COMMUNICATION DEVICE AND COMMUNICATION METHOD

(71) Applicant: NTT DOCOMO, INC., Tokyo (JP)

(72) Inventors: Tatsuki Okuyama, Tokyo (JP); Satoshi Suyama, Tokyo (JP); Nobuhide Nonaka, Tokyo (JP)

(73) Assignee: NTT DOCOMO, INC., Tokyo (JP)

(21) Appl. No.: 17/907,207

(22) PCT Filed: Feb. 10, 2021
(86) PCT No.: PCT/JP2021/005049

§ 371 Date: Sep. 23, 2022

(30) Foreign Application Priority Data
Mar. 27, 2020 (JP) 2020-058845

(51) Int. Cl. H04W 72/1268; H04W 72/54

(52) U.S. Cl. CPC H04W 72/1268; H04W 72/54

(57) ABSTRACT

A communication apparatus is disclosed including a reception unit that receives an uplink signal; a control unit that determines one or more signal processes to be applied to the uplink signal, among a plurality of signal processes for the uplink signal; and a transmission unit that transmits to a backhaul the uplink signal that received the determined one or more signal processes. In another aspect, a communication method is also disclosed.

### TECHNICAL FIELD

The present disclosure relates to a communication apparatus and a communication method.

### BACKGROUND ART

Long Term Evolution (LTE) has been specified for achieving a higher data rate, lower latency, and the like in a Universal Mobile Telecommunication System (UMTS) network. Future systems of LTE have also been studied for achieving a broader bandwidth and a higher speed based on LTE. Examples of the future systems of LTE include systems called LTE-Advanced (LTE-A), Future Radio Access (FRA), 5th generation mobile communication system (5G), 5G plus (5G+), Radio Access Technology (New-RAT), New Radio (NR), and the like.

### CITATION LIST

### Non-Patent Literature

### NPL 1

Telecommunication Technology Committee, “TR-1079 Technical Report on Optical Access for Fronthaul of 5th Generation Mobile Communication System,” v1.0, May 30, 2019

### SUMMARY OF INVENTION

### Technical Problem

For a radio communication system such as NR, backhaul (BH) transmission of an uplink (UL) signal has been under consideration.

One objective of the present disclosure is to optimize the amount of uplink signals to be transmitted to a backhaul.

### Solution to Problem

A communication apparatus according to an aspect of the present disclosure includes: a reception section that receives an uplink signal; a control section that determines at least one signal process to be applied to the uplink signal, among a plurality of signal processes for the uplink signal; and a transmission section that transmits, to a backhaul, an uplink signal which has been subjected to the determined at least one signal process.

### Advantageous Effects of Invention

According to the present disclosure, it is possible to control an application range of signal processing for uplink signals, thereby optimizing the amount of uplink signals to be transmitted to a backhaul.

### BRIEF DESCRIPTION OF DRAWINGS

FIG. 1 illustrates a configuration example of a radio communication system according to Embodiment 1;

FIG. 2 is a block diagram illustrating a configuration example of a terminal (UE) according to Embodiment 1;

FIG. 3 is a block diagram illustrating a configuration example of a base band unit (BBU) according to Embodiment 1;

FIG. 4 is a block diagram illustrating a configuration example of a central unit (CU) according to Embodiment 1;

FIG. 5 is a flowchart illustrating an operation example of the CU according to Embodiment 1;

FIG. 6 illustrates an exemplary reception waveform of an uplink (UL) signal in a BBU according to Embodiment 2;

FIG. 7A is a flowchart illustrating Operation Example 1 of a CU according to Embodiment 2;

FIG. 7B is a flowchart illustrating Operation Example 2 of a BBU according to Embodiment 2;

FIG. 8A illustrates an exemplary reception waveform of an uplink (UL) signal in two BBUs that perform UL coordinated reception according to a variation of Embodiment 2;

FIG. 8B illustrates another exemplary reception waveform of an uplink (UL) signal in two BBUs that perform the UL coordinated reception according to the variation of Embodiment 2;

FIG. 9A is a flowchart illustrating an operation example of a CU according to the variation of Embodiment 2;

FIG. 9B is a flowchart illustrating an operation example of a BBU according to the variation of Embodiment 2;

FIG. 10 describes an example of control according to Embodiment 3;

FIG. 11 describes an exemplary determination process according to Embodiment 4; and

FIG. 12 is a block diagram illustrating an exemplary hardware configuration of a CU, a BBU, and a UE.

### DESCRIPTION OF EMBODIMENTS

Embodiments will be described below with appropriate reference to the accompanying drawings. The same elements are denoted by the same reference numerals throughout the present specification unless otherwise specified. The following descriptions given in conjunction with the accompanying drawings are for explaining an exemplary embodiment but not for specifying the only embodiment. For example, in the case where the order of operations is described in the embodiment, the order of the operations may be appropriately changed as long as no inconsistency occurs in the operations as a whole.

When a plurality of embodiments and/or modifications are illustrated, some configurations, functions and/or operations in a certain embodiment and/or modification may be included in other embodiments and/or modifications, or may be replaced by corresponding configurations, functions and/or operations of other embodiments and/or modifications as long as no inconsistency occurs.

In addition, in the embodiment, an unnecessarily detailed description may be omitted. For example, detailed descriptions of publicly known or well-known technical matters may be omitted in order to avoid unnecessarily redundant descriptions and/or obscuring technical matters or concepts, so as to facilitate understanding by those skilled in the art. In addition, duplicate descriptions of substantially the same configurations, functions, and/or operations may be omitted.

The accompanying drawings and the following description are provided to assist those skilled in the art to understand the embodiment, but are not intended to limit the claimed subject matter. In addition, the terms used in the following description may be appropriately replaced with other terms to aid the understanding of those skilled in the art.

<Findings Leading to Present Disclosure>

In a radio communication system such as NR, it has been studied to implement beamforming or multi-user multiplexing (Multi-User-Multiple-Input and Multiple-Output (MU-MIMO)) transmission by MIMO transmission using a multi-element antenna (Massive MIMO).

Further, with respect to an uplink (UL) communication from a terminal (e.g., user equipment (UE)) to a base station, when the terminal is connected to a plurality of cells, improvement of UL reception throughput can be expected by performing UL reception in coordination (or in cooperation) between cells.

Here, in one example, when assuming MU-MIMO transmission in UL, a UL signal of a terminal located at a cell boundary (i.e., area where different cells overlap) arrives at an antenna of another cell, for example. In a case where a baseband unit (BBU) is provided for each cell, for example, signals are transmitted from a plurality of the BBUs to a central unit (CU). Note that the CU may be understood as, for example, an exemplary control apparatus (or inter-cell coordinated control apparatus) that controls operations of two or more BBUs.

The connection between a BBU and a CU is referred to as a backhaul (BH), and an optical fiber cable is used, for example. When UL signals for two or more terminals are transmitted to the CU via the BBUs by MU-MIMO, a transmission bandwidth of the optical fiber cable (may be also referred to as “BH bandwidth”) may be strained.

In the embodiments described below, for example, sharing of UL signal processing (or function) between a CU and a BBU (hereinafter may be also referred to as “UL signal processing application range” or simply as “application range”) is adaptively (or dynamically) controlled for each terminal.

The UL signal processing may include, for example, processes such as signal quantization, signal demodulation, and signal determination of 0 or 1. Accordingly, controlling the “application range” may be understood as controlling, for example, whether each of the processes of quantization, demodulation, and determination is performed in the BBU or in the CU.

By way of a non-limiting example, for a terminal located at a cell boundary and subject to UL coordinated reception, an application range of the UL signal processing between a CU and a BBU may be controlled based on at least one (or parameter) of information on the BH bandwidth and information on signal quality of the UL signal.

Such adaptive control of the “UL signal processing application range” may be performed by, for example, the initiative of the CU. The control of the “UL signal processing application range” makes it possible to, for example, control an application range of signal processing on a UL signal.

Thus, for example, it is possible to optimize the amount of UL signals transmitted by a BBU to a BH (i.e., CU). Consequently, for example, it is possible to save the BH bandwidth (i.e., improvement of utilization efficiency in the BH bandwidth).

Note that controlling (or changing) the application range of the UL signal processing may be understood as controlling (or changing) a functional division point (may be also referred to as “split point” or “divisional option”) between the CU and the BBU.

### Embodiment 1

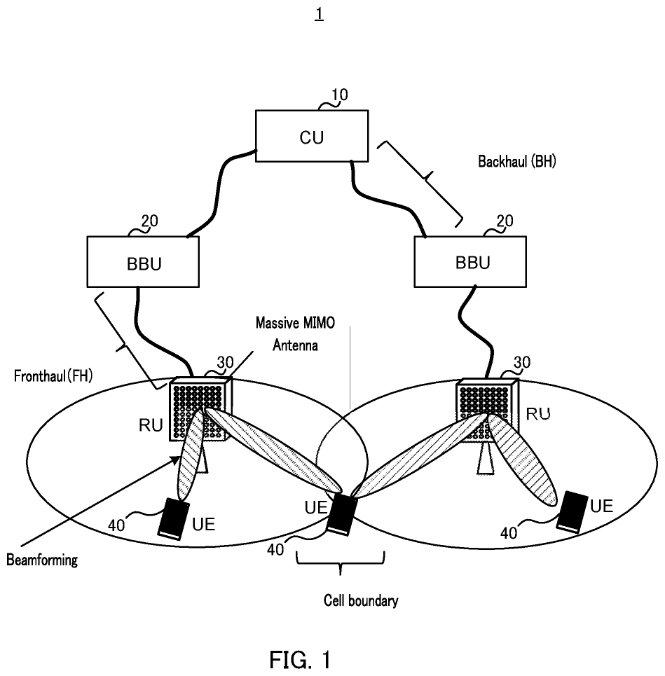

FIG. 1 illustrates a configuration example of radio communication system 1 according to Embodiment 1. Radio communication system 1 may be, for example, a system conforming to 3rd generation partnership project (3GPP) standards such as long term evolution (LTE), LTE-advanced (LTE-A), or new radio (NR), or may be a system conforming to further succeeding standards than NR.

As illustrated in FIG. 1, radio communication system 1 may include CU 10, BBUs 20, radio units (RUs) 30, and UEs 40. A communication apparatus including BBUs 20 and RUs 30 may be referred to as a “base station,” while a communication apparatus including CU 10, BBUs 20, and RUs 30 may be referred to as a “base station.”

The “BBU” may be referred to as, for example, a centralized baseband unit (CBBU), a radio equipment controller (REC), or a distributed unit (DU). The “RU” may be referred to as, for example, a remote radio head (RRH) or radio equipment (RE).

In FIG. 1, for example, CU 10 is connected (BH-connected) to two BBUs 20 by wired cables such as optical fiber cables. Note that three or more BBUs 20 may be connected to one CU 10.

CU 10 is connected to, for example, a core network (not illustrated). CU 10 transmits a signal addressed to UE 40 received from the core network to BBU 20 corresponding to RU 30 to which subject-UE 40 is wirelessly connected. CU 10 also receives, for example, from BBU 20, a signal transmitted by UE 40 and received at RU 30, and transmits the received signal to the core network.

BBU 20 is connected to one or more RUs 30 by a wired cable such as an optical fiber cable, for example. The connection between BBU 20 and RU 30 is referred to as, for example, a fronthaul (FH).

RU 30 includes, for example, a Massive MIMO antenna and is capable of controlling a directivity of a radio wave by using beamforming. RU 30 forms (or provides), for example, a radio communication area (e.g., cell). Hereinafter, RU 30 (or set of RU 30 and BBU 20 connected by FH) may be referred to as “cell 30,” for convenience.

Note that the term “radio communication area” may be replaced with other terms such as a “cell area,” a “sector,” a “sector area,” a “coverage area,” a “cover area,” a “radio area,” a “communication area,” a “service area,” and a “cluster area,” in addition to the “cell.”

UE 40 is, for example, wirelessly connected to any of cells 30 and performs radio communication with cell 30 that is connected. The radio communication between UE 40 and cell (serving cell) 30 includes at least one of transmission of an uplink (UL) signal and reception of a downlink (DL) signal. A UL signal transmitted by UE 40, for example, after being received at RU 30, is transmitted to BBU 20 connected to subject-RU 30 and then transmitted from subject-BBU 20 to CU 10.

A DL channel transmitting a DL signal may include, for example, a physical downlink control channel (PDCCH), which is an exemplary control channel, and a physical downlink shared channel (PDSCH), which is an exemplary data channel.

A UL channel transmitting a UL signal may include, for example, a physical uplink control channel (PUCCH), which is an exemplary control channel, and a physical uplink shared channel (PUSCH), which is an exemplary data channel.

Note that the DL channel and the UL channel are not limited to the above-mentioned PDCCH, PDSCH, PUCCH, and PUSCH. For example, the DL channel and the UL channel may include another channel such as a broadcast channel (physical broadcast channel, PBCH) and/or a random access channel (RACH).

Further, a single-carrier transmission scheme or a multi-carrier transmission system may be applied to the radio communication in one or both of DL and UL. A non-limiting example of the single-carrier transmission scheme includes DFT-S-OFDM. The term “DFT-S-OFDM” is an abbreviation for Discrete Fourier Transform (DFT)-Spread-Orthogonal Frequency Division Multiplexing (OFDM).

UE 40 may be connected to a plurality of cells 30. For example, a UL signal transmitted by UE 40 located at a boundary of different cells 30 may be received by RUs 30 respectively corresponding to different cells 30. When attention is focused on coordinated reception of the UL signal, the UL signal received at different cells 30 is transmitted to CU 10 via, for example, BBUs 20 corresponding to individual cells 30.

A DL signal is transmitted from CU 10 to RU 30 via BBU 20 and then wirelessly transmitted from RU 30 to UE 40. When UE 40 is located at a cell boundary, CU 10 may, for example, perform coordinated transmission with a plurality of cells 30 with respect to DL. An example of the DL coordinated transmission with the plurality of cells 30 includes coordinated scheduling (CS), coordinated beamforming (CB), joint transmission (JT), or dynamic point selection (DPS).

(Configuration Example of UE 40)

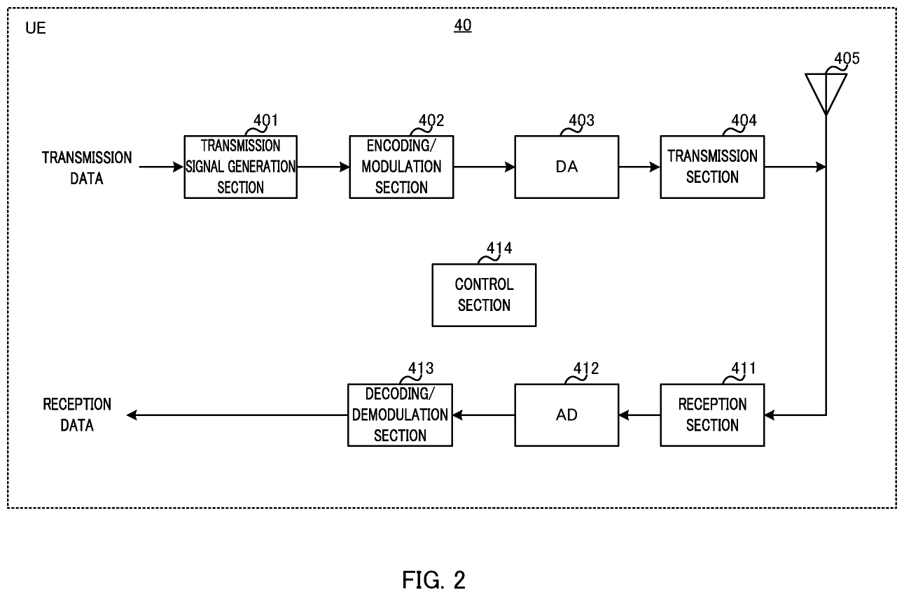

FIG. 2 is a block diagram illustrating a configuration example of UE 40. As illustrated in FIG. 2, UE 40 includes, for example, transmission signal generation section 401, encoding/modulation section 402, digital-to-analog (DA) conversion section 403, transmission section 404, antenna 405, reception section 411, analog-to-digital (AD) conversion section 412, decoding/demodulation section 413, and control section 414.

Transmission signal generation section 401 generates a transmission signal from transmission data (e.g., at least one of a data signal and a control signal on UL may be included therein). The generated transmission signal is output to encoding/modulation section 402, for example.

Encoding/modulation section 402, for example, performs encoding processing and modulation processing on the transmission signal from transmission signal generation section 401, based on modulation and coding scheme (MCS) information input from control section 414. An output of encoding/modulation section 402 is output to, for example, DA conversion section 403. For the encoding, a code such as a turbo code, a low density parity check (LDPC) code, and/or a polar code may be used. Further, for the modulation, a modulation scheme such as quadrature phase shift keying (QPSK) and/or quadrature amplitude modulation (QAM) may be used.

DA conversion section 403, for example, converts a digital signal that is the output of encoding/modulation section 402 into an analog signal and outputs it to transmission section 404.

Transmission section 404 performs radio transmission processing such as frequency conversion (e.g., up conversion) and/or amplification on the analog signal from DA conversion section 403 to generate a radio signal on UL and transmits the radio signal from antenna 405.

Reception section 411, for example, performs radio reception processing such as low noise amplification and/or frequency conversion (e.g., down conversion) on a DL radio signal received by antenna 405, and outputs the received analog signal on DL to AD conversion section 412.

AD conversion section 412, for example, converts the received analog signal from reception section 411 into a digital signal and outputs it to decoding/demodulation section 413.

Decoding/demodulation section 413, for example, demodulates and decodes the received digital signal from AD conversion section 412, based on MCS information from control section 414. Demodulation and decoding schemes respectively corresponding to the encoding and modulation schemes used for DL on a transmission side in DL (e.g., BBU 20) may be applied to the demodulation and decoding.

Control section 414 controls, for example, an operation of UE 40, e.g., operations of the respective sections 401 to 404 and 411 to 413 mentioned above. For example, the control by control section 414 may include control for one or both of UL transmission and DL reception based on a control signal received by reception section 411.

For example, control such as channel estimation based on a reference signal (e.g., DMRS) received by reception section 411 and/or control of the MCS based on the channel estimation result may be performed or controlled by control section 414.

In addition, for example, mapping or demapping for a radio resource of a signal based on scheduling information (e.g., information on radio resource allocation with respect to at least one of DL and UL) received by reception section 411 may be performed or controlled by control section 414.

Note that for OFDM, for example, with respect to the UL transmission, inverse fast Fourier transform (IFFT) (or inverse discrete Fourier transform (IDFT)) processing and guard interval (GI) addition processing may be performed between encoding/modulation section 402 and DA conversion section 403. Further, for OFDM, for example, with respect to the DL reception, fast Fourier transform (FFT) (or discrete Fourier transform (DFT) processing and GI removal processing may be performed between AD conversion section 412 and decoding/demodulation section 413.

(Configuration Example of BBU 20)

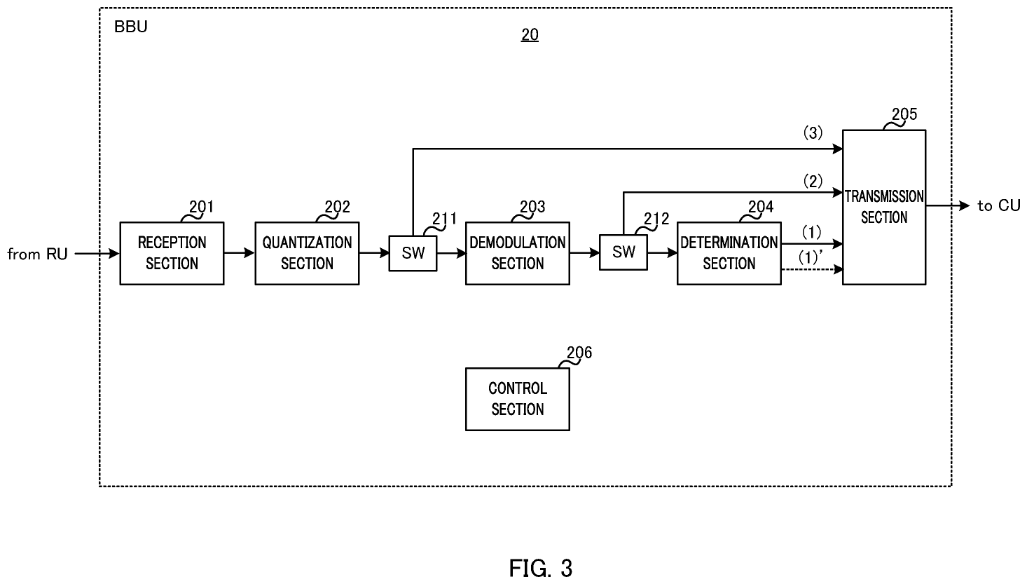

Next, with reference to FIG. 3, a configuration example of BBU 20 will be described. As illustrated in FIG. 3, when focusing on a reception system in UL, BBU 20 includes, for example, reception section 201, quantization section 202, demodulation section 203, determination section 204, transmission section 205, and control section 206.

Further, for example, between quantization section 202 and demodulation section 203, switch (SW) 211 may be provided, and between demodulation section 203 and determination section 204, SW 212 may be provided. Note that a transmission system in DL is not illustrated in FIG. 3.

Quantization section 202, demodulation section 203, and determination section 204 may be understood as non-limiting examples of a plurality of signal processing sections. Further, a quantization process by quantization section 202, a demodulation process by demodulation section 203, and a determination process of 0 or 1 by determination section 204 may be understood as non-limiting examples of a first process, a second process, and a third process, respectively.

Reception section 201, for example, receives a UL signal (analog signal) transmitted from RU 30 to BBU 20 through the optical fiber cable and outputs the received signal to quantization section 202.

Quantization section 202, for example, quantizes the received signal from reception section 201. Note that for example, prior to the quantization, a sample (i.e., sampling) process may be performed on the received signal. For example, in a case where a signal unsampled in RU 30 is output from reception section 201, the sampling may be performed in BBU 20 prior to the quantization process by quantization section 202. On the other hand, for example, in a case where a signal sampled in RU 30 is output from reception section 201, the sampling need not be performed in BBU 20 prior to the quantization. At least one of a degree of quantization (e.g., the number of quantization bits) and an extent (or quantization range) in quantization section 202 may be controlled by, for example, control section 206.

SW 211, for example, selectively outputs the output of quantization section 202 to either demodulation section 203 or transmission section 205 in accordance with the control from control section 206. When an output destination of SW 211 is switched to transmission section 205, processes in demodulation section 203 and determination section 204 are skipped (or bypassed).

Demodulation section 203, for example, demodulates the quantized signal (digital signal) input from SW 211, based on MCS information from control section 206. Demodulation schemes respectively corresponding to the modulation schemes used for UL on a transmission side in UL (e.g., UE 40) may be applied to the demodulation.

SW 212, for example, selectively outputs an output of demodulation section 203 to either determination section 204 or transmission section 205 in accordance with the control from control section 206. When an output destination of SW 212 is switched to transmission section 205, the determination process by determination section 204 is skipped (or bypassed).

Determination section 204, for example, performs determination (e.g., soft determination) on the signal (i.e., output of demodulation section 203) input from SW 212 and outputs a determination result to transmission section 205.

Depending on the configuration (or control) by SWs 211 and 212, for example, any of the following is input to transmission section 205:

(1) Output of determination section 204;

(2) Output of SW 212 (i.e., output of demodulation section 203); and

(3) Output of SW 211 (i.e., output of quantization section 202).

Transmission section 205 transmits the input signal to CU 10 through the BH (e.g., optical fiber cable).

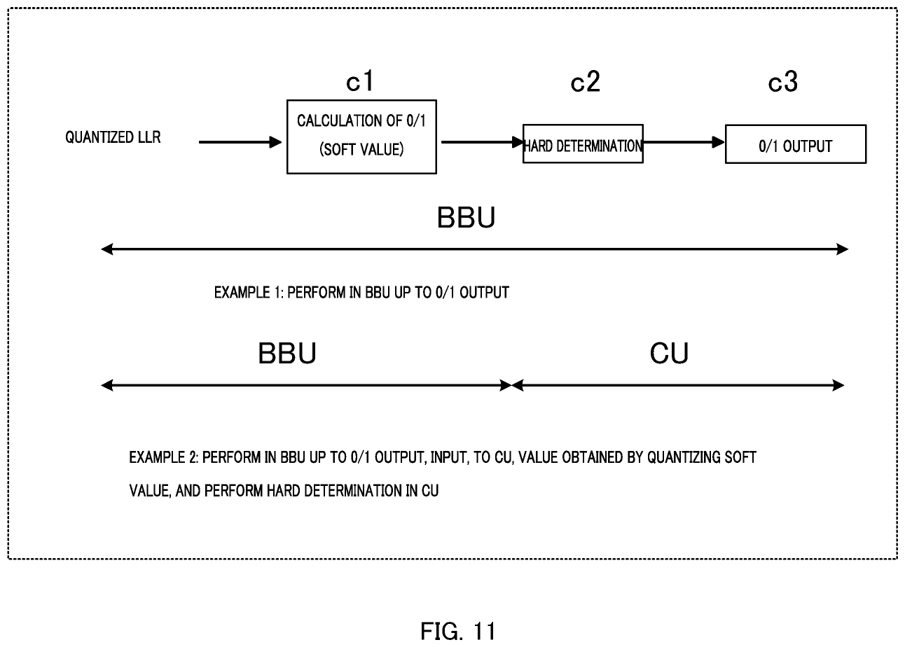

In other words, the switching control by SWs 211 and 212 enables BBU 20 illustrated in FIG. 3 to change a content of a signal to be transmitted to CU 10 into any of (1) to (3) mentioned above. In the following, for convenience, the outputs (signals) in the above-described (1) to (3) may be also referred to as signals (1) to (3), respectively. Note that signal (1)′ indicated by the dotted arrow in FIG. 3 will be described later in Embodiment 4 (FIG. 11).

Control section 206, for example, may control an operation of BBU 20, e.g., operations of the respective sections 201 to 205 mentioned above. For example, the control by control section 206 may include control (or configuration) of the MCS. Further, the control by control section 206 may include, for example, controlling the output destinations of SWs 211 and 212 based on information indicating sharing (application range) of the signal processing with respect to a UL signal (hereinafter, may be also abbreviated as “application range information”). Additionally, for example, the control by control section 206 may include configuration or control of a parameter (e.g., at least one of the number of quantization bits and quantization range) relating to the quantization by quantization section 202.

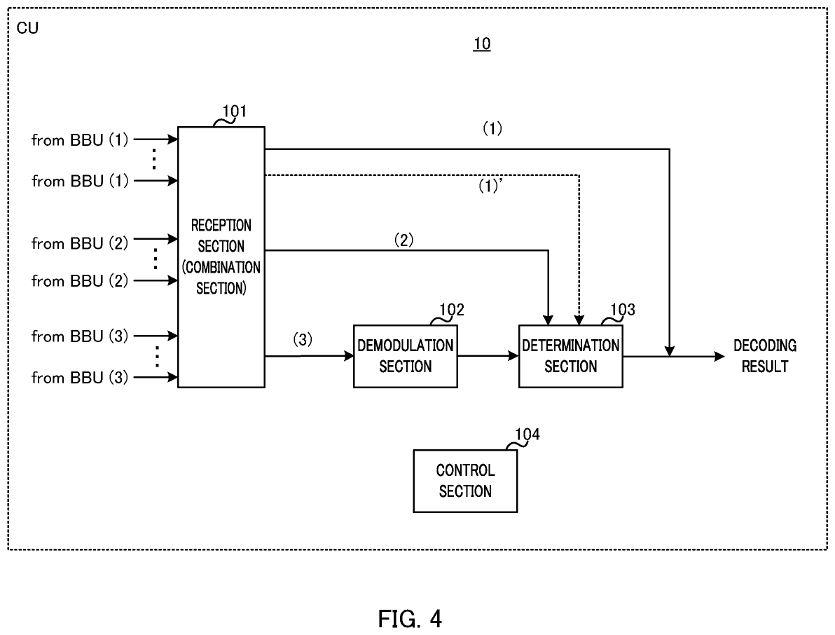

The “application range information” may be stored in, for example, a memory (not illustrated) provided in CU 10. Further, the “application range information” may be received from CU 10 (e.g., control section 104 described later in FIG. 4). For example, the “application range information” may be included in a DL control signal transmitted to BBU 20 so as to be provided to control section 206 of BBU 20, or may be provided to BBU 20 from CU 10 by control communication specific between BBU 20 and CU 10.

(Configuration Example of CU 10)

Next, a configuration example of CU 10 will be described with reference to FIG. 4. As illustrated in FIG. 4, CU 10 includes, for example, reception section (combination section) 101, demodulation section 102, determination section 103, and control section 104.

Reception section (combination section) 101 receives, for example, a signal transmitted from one or more BBUs 20 to CU 10. Here, by the above-mentioned switching in SWs 211 and 212 of BBU 20, any of the signals (1) to (3) is received by reception section 101 of CU 10. Note that signal (1)′ indicated by the dotted arrow in FIG. 4 will be described later in Embodiment 4 (FIG. 11).

A set of signals (1), a set of signals (2), and a set of signals (3) received from two or more BBUs 20 may be each combined in reception section 101. For example, the set of signals (1) may be combined in reception section 101 and then output. The set of signals (2) may be combined in reception section 101 and then output to determination section 103. The set of signals (3) may be combined in reception section 101 and then output to demodulation section 102.

A combination method for a plurality of signals in reception section 101 is not particularly limited. For example, any of plural types of combination methods such as selective combination, maximal ratio combination, and equal gain combination may be used in reception section 101. Further, for example, a combination method in reception section 101 may be switched depending on a set of signals received from BBUs 20.

Demodulation section 102, for example, demodulates signals (3) from reception section 101 and outputs them to determination section 103.

Determination section 103, for example, determines (e.g., hard determination) one of the output of demodulation section 102 and signals (2) from reception section 101.

Control section 104 controls, for example, an operation of CU 10, e.g., operations of the respective sections 101 to 103 mentioned above. For example, the control by control section 104 may include determining a signal set to be combined in reception section 101 and controlling the signal combination in reception section 101. Further, for example, the control by control section 104 may include control (or configuration) of the MCS.

### Operation Example

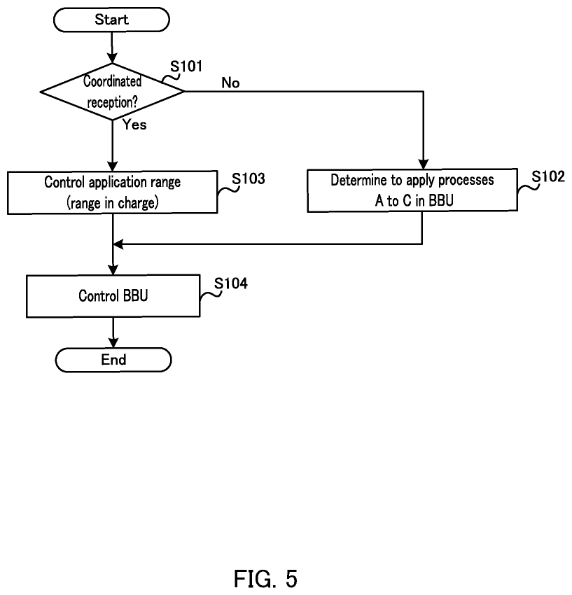

Next, with reference to FIG. 5, an operation example in Embodiment 1 will be described. FIG. 5 is a flowchart illustrating an operation example of CU 10. As illustrated in FIG. 5, CU 10 (e.g., control section 104), for example, determines whether UE 40 is a target of UL coordinated reception (hereinafter may be also referred to as UL coordinated reception target) (S101).

This determination may be performed based on, for example, whether UE 40 is located at a cell boundary. For example, CU 10 can determine whether UE 40 is located at the boundary by receiving, from BBU 20, information on cell 30 in which UE 40 is located (i.e., cell 30 to which UE 40 is connected).

For example, CU 10 may determine UE 40 located at the cell boundary as a UL coordinated reception target (S101; No). CU 10 may determine UE 40 not located at the cell boundary as a UL non-coordinated reception target (S101; Yes).

Incidentally, when a plurality of UL signals is combined in the UL coordinated reception, the signal determination accuracy is improved. In a case where processes A to C are performed in this order, for example, combination of signals is preferably performed, in terms of the accuracy, at the earliest possible stage of processes A to C. Whereas, information obtainable at the early stage of processes A to C is large in the amount of information; thus, transmitting, from BBU 20 to the BH, the information obtained in the process at the early stage consumes the BH bandwidth. In other words, in terms of BH bandwidth saving, it is preferable to perform as many processes of processes A to C as possible in BBU 20. Thus, a trade-off relationship is present between the “accuracy improvement by signal combination” and the “consumption of BH bandwidth.”

The signal combination is not required for UE 40 that is a non-coordinated reception target; accordingly, in terms of the BH bandwidth saving, CU 10 determines, for example, to perform three kinds of processes A to C: quantization, demodulation, and determination for a UL signal in BBU 20 (S102). In other words, CU 10 determines to cause BBU 20 to transmit signal (1) of signals (1) to (3) to CU 10.

In response to this determination, CU 10 configures (or controls) the output destination of SW 211 to demodulation section 203 and the output destination of SW 212 to determination section 204, for example, by providing “application range information” to applicable BBU 20 (S104).

By such configuration (or control), in BBU 20, the output of quantization section 202 is determined by determination section 204 after being demodulated by demodulation section 203, and a determination result is transmitted from transmission section 205 to CU 10. In other words, none of processes in demodulation section 203 and in determination section 204 is skipped (or bypassed) in BBU 20.

On the other hand, with respect to UE 40 that is a coordinated reception target, in terms of the determination accuracy improvement and the BH bandwidth saving by the signal combination, CU 10 adaptively determines a process to be performed in BBU 20 among processes A to C. For example, for UE 40 that is the coordinated reception target, CU 10 adaptively controls (or determines) the application range (range in charge) of the processing with respect to a UL signal in BBU 20, based on at least one of a BH bandwidth and reception quality (e.g., received power) of the UL signal (S103).

For example, CU 10 (e.g., control section 104) may adaptively determine the process to be performed in BBU 20 (or process to be performed in CU 10) among three processes A to C of quantization, demodulation, and determination in process S103.

(a) BBU 20: Processes A to C

(b) BBU 20: Process A (CU 10: Processes B and C)

(c) BBU 20: Processes A and B (CU 10: Process C)

As a non-limiting example of the adaptive control in process S103, when an usage amount (or usage rate) of the BH bandwidth exceeds a threshold value, (a) is applied for the purpose of saving of the BH bandwidth, whereas (b) or (c) is applied when the BH bandwidth is not greater than the threshold value (i.e., BH bandwidth is not strained).

In (a), in CU 10, output signals (1) (result of determination process C; 0 or 1) of BBUs 20 are received, combined, and output by reception section 101.

In (b), in CU 10, signals (3) which have been subjected to the quantization process A in BBUs 20 are received and combined by reception section 101, and then, demodulation process B by demodulation section 203 and determination process C by determination section 204 are performed on combined signal (3).

In (c), in CU 10, signals (2) which have been subjected to quantization process A and demodulation process B in BBUs 20 are received and combined by reception section 101, and then, combined signal (2) is determined by determination section 204 (Process C).

Note that the usage amount (or usage rate) of the BH bandwidth may be obtained by, for example, indicating, from CU 10 to each BBU 20, a monitoring result of the BH bandwidth by CU 10 (e.g., control section 104).

Alternatively, for example, a threshold value of the information amount allowed to be transmitted from each BBU 20 to CU 10 is determined in advance, based on a history (or may be simulation) relating to the usage amount (or usage rate) of the BH bandwidth. Sharing the determined threshold value between CU 10 and BBUs 20 may achieve the adaptive control of the application range with respect to processes A to C described above.

The threshold value may be the same or different between BBUs 20. For example, different threshold values may be set or a threshold value may be varied for each of BBUs 20, depending on at least one of a temporal element and a geographic element. For example, for BBU 20 where the amount of UL information from UE 40 is assumed to be large geographically or temporally, a threshold value may be set greater than that for BBU 20 where the amount of UL information from UE 40 is assumed to be small geographically or temporally.

### Embodiment 2

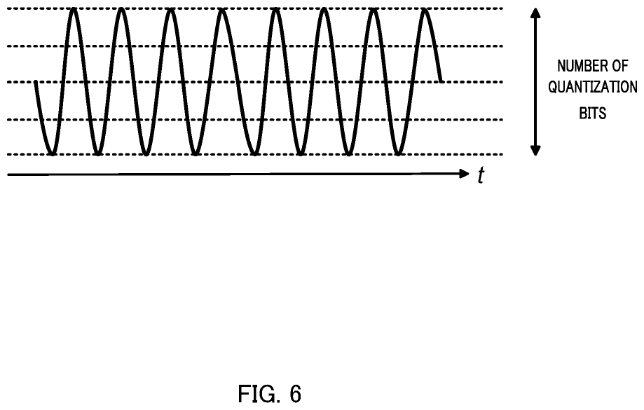

Next, Embodiment 2 will be described with reference to FIGS. 6 to 8. In Embodiment 2, a description will be given of an example of controlling (or adjusting) the number of quantization bits in quantization process A (quantization section 202 of BBU 20) mentioned above.

This control of the amount of quantization bits may be understood as being applied, in Embodiment 1, to quantization section 202 of BBU 20 when process B and process C are performed in CU 10 on UE 40 that is a UL coordinated reception target.

FIG. 6 illustrates an exemplary reception waveform of a UL signal in BBU 20, and BBU 20 (e.g., control section 206) may adjust the number of quantization bits in quantization section 202 (e.g., step size of vertical axis in FIG. 6), for example. Note that the levels of five stages are illustrated in FIG. 6, and the number of quantization bits may be three, for example.

### Operation Example 1

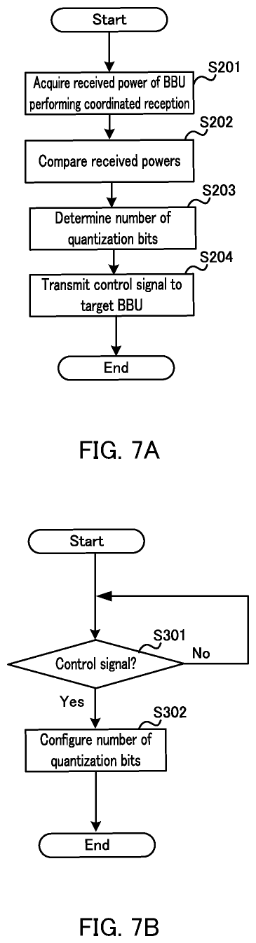

For example, as illustrated in FIG. 7A, CU 10 (e.g., control section 104) acquires and compares received powers (Ps) of UL signals in BBUs 20 performing UL coordinated reception (S201 and S202).

As a result of the comparison, for example, CU 10 determines to increase the number of quantization bits for BBU 20 with a relatively high received power and determines to decrease the number of quantization bits for BBU 20 with a relatively high received power (S203).

Then, CU 10 generates a control signal indicating the increase or decrease in the number of quantization bits and transmits the control signal to target BBU 20 via the BH (S204).

In BBU 20 performing the UL coordinated reception, as illustrated in FIG. 7B, for example, whether the control signal relating to the number of quantization bits is received is monitored by, for example, control section 206 (S301; No), and when the control signal is received (S301; Yes), control section 206 performs configuration for quantization section 202 according to the received control signal (S302).

For example, in BBU 20 with the relatively high UL received power, control section 206 applies, to quantization section 202, a configuration for increasing the number of quantization bits. On the other hand, in BBU 20 with the relatively low UL received power, control section 206 applies, to quantization section 202, a configuration for decreasing the number of quantization bits.

That is, the number of quantization bits in quantization section 202 is increased in BBU 20 with the high UL received power P (i.e. more reliable BBU) whereas the number of quantization bits in quantization section 202 is decreased in BBU 20 with the low UL received power P.

In the manner described above, by adjusting of the number of quantization bits of the UL signal that is the coordinated reception target, the number of quantization bits is increased for the UL signal a having high received power P, which can improve, for example, the accuracy of determination process C (e.g., detection or estimation of signal). On the other hand, the number of quantization bits is decreased for the UL signal having a low received power P, which reduces the amount of information transmitted from BBU 20 to the BH toward CU 10. Thus, it is possible to save the BH bandwidth.

### Operation Example 2

Alternatively, with respect to the control of the number of quantization bits, CU 10 (e.g., control section 104) and BBU 20 (e.g., control section 206) may perform adjustment opposite to Operation Example 1 mentioned above.

For example, the number of quantization bits in quantization section 202 is decreased in BBU 20 with a high UL received power P (i.e. more reliable BBU) whereas the number of quantization bits in quantization section 202 is increased in BBU 20 with a low UL received power P.

Since the UL signal having the high received power can be said to have relatively high reliability, it can be determined that the influence on determination process C (i.e., signal detection of 0 or 1) is small even when the number of quantization bits is decreased. Accordingly, the amount of information transmitted from BBU 20 to the BH toward CU 10 can be reduced, and thus, it is possible to save the BH bandwidth. On the other hand, since the number of quantization bits is increased for the UL signal having the low received power, it is possible to improve the signal detection accuracy.

Note that Operation Example 1 and Operation Example 2 described above indicate the examples in which, between the UL signals that are the UL coordinated reception targets (i.e., between BBUs 20), the number of quantization bits is increased on one side and the number of quantization bits is decreased on the other side, but control may be applied in which the number of quantization bits is increased or decreased on both sides.

For example, when the BH bandwidth is not tight, the number of quantization bits may be increased on both sides, and when the BH bandwidth is tight, the number of quantization bits may be decreased on both sides. Further, when the BH bandwidth is not tight and when the received power of each of the UL signals that are the coordinated reception targets is less than the threshold value, the number of quantization bits may be increased on both sides.

Alternatively, control may be applied in which the number of quantization bits is increased or decreased for one side of the UL signals that are the coordinated reception targets and the number of quantization bits is maintained (i.e., not changed) for the other side of the UL signals that are the coordinated reception targets, depending on the usage amount of the BH bandwidth. An increase or decrease range in the number of quantization bits may be the same or different between BBUs 20.

Further, for example, in a case where a difference greater than a certain threshold value is present (i.e., there is a large difference in reliability) between the UL received powers of the UL coordinated reception targets, saving of the BH bandwidth may be attempted by not quantizing (or not transmitting to BH) the signal on the lower reliability side.

Further, in Embodiment 1 described above, the example has been described in which CU 10 performs the control of the number of quantization bits with respect to BBUs 20 performing the UL coordinated reception, but, for example, each of BBUs 20 performing the UL coordinated reception may autonomously control the number of quantization bits. For example, a threshold value or threshold range of the UL received power may be set in advance for each BBU 20, and an increase or decrease in the number of quantization bits may be controlled by threshold determination.

### Variation of Embodiment 2

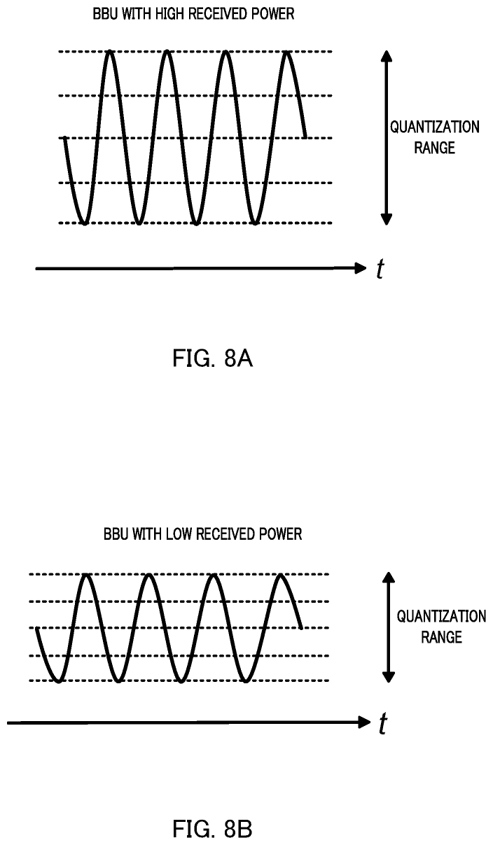

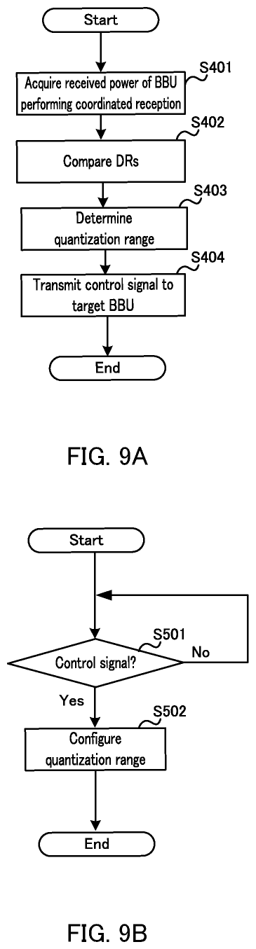

Next, with reference to FIG. 8A, FIG. 8B, FIG. 9A, and FIG. 9B, a variation of Embodiment 2 will be described. FIG. 8A and FIG. 8B are diagrams illustrating exemplary reception waveforms of UL signals in two BBUs 20 that perform UL coordinated reception.

FIG. 8A illustrates a reception waveform with a relatively high received power (i.e., dynamic range (DR) of the received power is relatively wide). FIG. 8B illustrates a reception waveform with a relatively low received power (i.e., DR of the received power is relatively narrow). Note that between FIG. 9A and FIG. 9B, the number of quantization bits indicated on the vertical axis is the same.

In the present variation, CU 10 (e.g., control section 104) and BBU 20 (e.g., control section 206) performing the UL coordinated reception may adjust a quantization range in quantization section 202, or the quantization range and the number of quantization bits, based on a received power (e.g., DR) of a UL signal.

An operation example according to the present variation is illustrated in FIG. 9A and FIG. 9B. As illustrated in FIG. 9A, CU 10 (e.g., control section 104) acquires received powers (Ps) of UL signals in BBUs 20 performing the UL coordinated reception and compares DRs of both BBUs (S401 and S402).

As a result of the comparison, for example, CU 10 determines to increase the quantization range for BBU 20 with a relatively high received power (wide DR) and determines to decrease the number of quantization bits for BBU 20 with a relatively high received power (narrow DR) (S403).

Then CU 10 generates a control signal indicating the increase or decrease in the quantization range and transmits the control signal to target BBU 20 via the BH (S404).

In BBU 20 performing the UL coordinated reception, as illustrated in FIG. 9B, for example, whether the control signal relating to the quantization range is received is monitored by, for example, control section 206 (S501; No). When the control signal is received (S501; Yes), control section 206 performs configuration of the quantization range for quantization section 202 according to the received control signal (S502).

For example, in BBU 20 with the relatively wide DR of the UL signal, control section 206 applies, to quantization section 202, a configuration for increasing (or expanding) the quantization range. On the other hand, in BBU 20 with the relatively narrow DR of the UL signal, control section 206 applies, to quantization section 202. a configuration for decreasing (or reducing) the quantization range.

In a case where the number of quantization bits is not changed, reducing the quantization range makes the step size of quantization (or granularity) substantially fine, thereby improving the signal determination accuracy after quantization. Thus, it is possible to improve the accuracy of the UL signal having a relatively narrow DR and low reliability of the UL signal (without adjusting the number of quantization bits).

Note that the above-mentioned variation of Embodiment 2 is the example in which, between the UL signals that are the UL coordinated reception targets (i.e., between BBUs 20), the quantization range is increased on one side and the quantization range is decreased on the other side, but control may be applied in which the quantization range is expanded or reduced on both sides.

Alternatively, control may be applied in which the quantization range is expanded or reduced for one side of the UL signals that are the coordinated reception targets and the quantization range is maintained (i.e., not changed) for the other side of the UL signals that are the coordinated reception targets, depending on the usage amount of the BH bandwidth. An expansion or reduction range in the quantization range may be the same or different between BBUs 20.

Further, in the above-mentioned variation of Embodiment 2, the example has been described in which CU 10 performs the control of the quantization range with respect to BBUs 20 performing the UL coordinated reception, but, for example, each of BBUs 20 performing the UL coordinated reception may autonomously control the quantization range. For example, a threshold value or threshold range of the DR of the UL signal may be set in advance for each BBU 20, and an expansion or reduction in the quantization range may be controlled by threshold determination.

Further, CU 10 and BBU 20 may apply, to quantization section 202, the adjustment of the number of quantization bits described in Embodiment 2 after the above-mentioned adjustment of the quantization range.

Adjusting the number of quantization bits makes it possible to additionally obtain the same operational effect as in Embodiment 2. The adjustment of the number of quantization bits may be performed before or after the adjustment of the quantization range described above, or may be performed in parallel with the adjustment of the quantization range.

### Embodiment 3

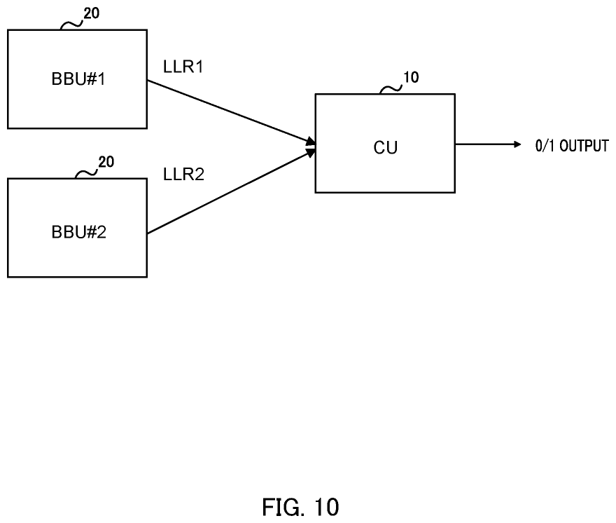

Next, with reference to FIG. 10, Embodiment 3 will be described. In Embodiment 3, a description will be given of balancing control of an output amount of information from demodulation process B, of the aforementioned processes A to C. The balancing control may be understood as being applied, in Embodiment 1, to demodulation section 203 of BBU 20 when determination process C is performed in CU 10 on UE 40 that is a UL coordinated reception target.

As illustrated in FIG. 10, in each of BBUs 20 (BBU #1 and BBU #2) performing the UL coordinated reception, log-likelihood-ratio (LLR) information can be obtained, in demodulation section 203, as an example of a soft-determination demodulation signal.

In FIG. 10, LLR 1 indicates LLR information obtainable in demodulation section 203 of BBU #1, and LLR 2 indicates LLR information obtainable in demodulation section 203 of BBU #2. Note that the LLR may be referred to as “soft determination value” or simply as “soft value.”

Here, BBU 20 performing UL coordinated reception (e.g., control section 206) may control (or adjust) the information amount of LLRs to be transmitted to CU 10 through the BH based on, for example, a received power of a UL signal that is a coordinated reception target.

### Operation Example 1

For example, in BBU 20 with a high received power of the UL signal that is the coordination reception target (supposed BBU #1), the number of quantization bits of LLR 1 is increased. On the other hand, in BBU 20 with a low received power of the UL signal that is the coordination reception target (supposed BBU #2), the number of quantization bits of LLR 2 is decreased.

Such adjustment of the number of quantization bits of LLRs makes it possible to improve the determination accuracy for the UL signal having a relatively high reception power (i.e., high reliability) while to save the BH bandwidth by reducing the information amount of the UL signal having a relatively low received power.

### Operation Example 2

Instead of Operation Example 1, adjustment of the number of quantization bits opposite to Operation Example 1 may be applied to demodulation section 203.

In one example, in BBU 20 with a high received power of a UL signal that is a coordination reception target (supposed BBU #1), the number of quantization bits of LLR 1 is decreased. On the other hand, in BBU 20 with a low received power of a UL signal that is a coordination reception target (supposed BBU #2), the number of quantization bits of LLR 2 is increased.

Since the UL signal having the high received power can be said to have relatively high reliability, it can be determined that the influence on determination process C (i.e., signal detection) is small even when the number of quantization bits is decreased. Accordingly, the amount of information transmitted from BBU 20 to the BH toward CU 10 can be reduced, and thus, it is possible to save the BH bandwidth. On the other hand, since the number of quantization bits is increased for the UL signal having the low received power, it is possible to improve the signal determination accuracy.

### Embodiment 4

Next, with reference to FIG. 11, Embodiment 4 will be described. In Embodiment 4, among the aforementioned processes A to C, determination process C (e.g., hard determination) will be described.

As illustrated in FIG. 11, determination process C may exemplarily include soft value calculation (soft determination) process C1 based on quantized LLR information, hard determination process C2 based on a soft value, and output process c3 of a hard determination result (bit value of 0 or 1).

Here, processes c1 to c3 may be performed in BBU 20 (Example 1), or process c1 may be performed in BBU 20 while processes c2 and c3 may be performed in CU 10 (Example 2).

That is, determination process C may be divided (or classified) into processes c1 to c3. All of determination process C may be performed in BBU 20, or a part (soft determination) is performed in BBU 20 while the remainder (hard determination) may be performed in CU 10.

Note that signals (1)′ indicated by the dotted arrows in FIGS. 3 and 4 represent the case of Example 2. For example, a soft determination value by determination section 204 of BBU 20 (FIG. 3) is transmitted to CU 10 by transmission section 205, and hard determination is performed in determination section 103 of CU 10 (FIG. 4).

In the former case (Example 1), it is possible to save the BH bandwidth between CU 10 and BBUs 20. In contrast, in the latter case (Example 2), a soft value is output from each of BBUs 20 performing UL coordination reception, and the output values are combined and thus subjected to the hard determination in CU 10. Therefore, when the soft determination and the hard determination is dispersed in BBUs 20 and CU 10, although the information amount to the BH may be increased, the improvement of the final signal detection accuracy in CU 10 can be expected.

Further, in each BBU 20 performing the UL coordinated reception, a parameter relating to quantization of the soft value calculation result by process c1 (e.g., the number of quantization bits or quantization range) may be adjusted as described in Embodiment 2 or 3, for example. Such adjustment makes it possible to adjust the information amount or the detection accuracy of a UL signal depending on the reception quality (e.g., received power) of the UL signal.

<Others>

In the embodiments (including the variations) described above, the examples have been described of controlling the number of quantization bits or the quantization range, based on the received power (or the dynamic range thereof), but the present disclosure is not limited to these examples. For example, the number of quantization bits or the quantization range may be controlled based on another signal quality indicator different from the received power, such as a received signal strength indicator (RSSI), a signal-to-noise ratio (SNR), and/or a bit (or block) error rate.

The functional sections of one or both of CU 10 and BBU 20 may be implemented by a logical “slice” using a virtualization technology. By way of example, processes A to C may be each generated by a slice. For example, the control of the application range of the UL signal processing between CU 10 and BBUs 20 described in the above-mentioned embodiments may be implemented by generation (or activation) and deletion (or deactivation) of a “slice.”

Further, for OFDM, for example, between quantization section 202 and demodulation section 203 of BBU 20 (e.g., see FIG. 3), the GI removal processing and the FFT processing may be performed on a UL signal in this order. In this case, (a) a signal before the FFT processing and after the GI removal processing or (b) a signal before the demodulation processing and after the FFT processing may be transmitted from BBU 20 to CU 10 (e.g., see FIG. 4).

In the case of (a), in CU 10, for example, the FFT processing may be performed on the signal after the GI removal processing from BBU 20 by a section positioned before demodulation section 102. In the case of (b), the signal after the FFT processing from BBU 20 may be input to demodulation section 102 of CU 10 and thereby subjected to the demodulation process.

(Hardware Configuration)

Note that, the block diagrams used to describe the above embodiment illustrate blocks on a function-by-function basis. These functional blocks (component sections) are implemented by any combination of at least one of hardware and software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit,” “transmission section,” or “transmitter.” The methods for implementing the functions are not limited specifically as described above.

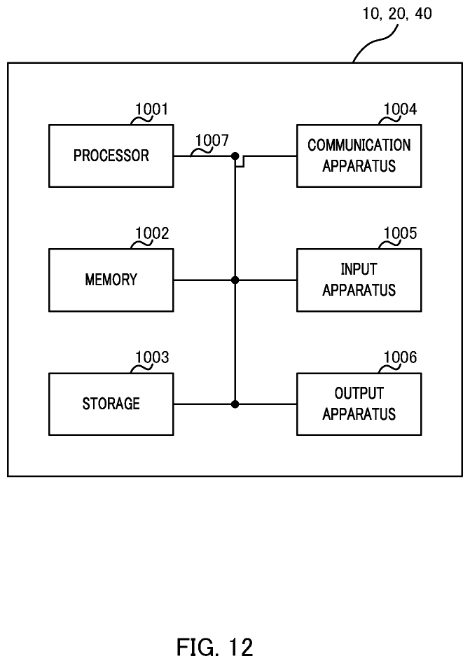

For example, the above-mentioned CU 10, BBU 20, UE 40, and the like may function as a computer that performs processing of the present disclosure. FIG. 12 is a block diagram illustrating an exemplary hardware configuration of CU 10, BBU 20, and UE 40. CU 10, BBU 20, and UE 40 may be physically constituted as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of CU 10, BBU 20, and UE 40 may include one apparatus or a plurality of apparatuses each illustrated in FIG. 4, FIG. 3, and FIG. 2 or may not include part of the apparatuses.

The functions of CU 10, BBU 20, and UE 40 are implemented by predetermined software (program) loaded into hardware, such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control sections 104, 206, 414 and/or the like as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control section 104, 206, or 414 may be implemented by a control program stored in memory 1002 and operated by processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to an embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and wireless networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, reception sections 101, 201, and 411, transmission sections 205, 404, and the like as described above may be implemented using communication apparatus 1004.

Input apparatus 1005 is an input device (for example, a keyboard, a mouse, a microphone, a switch, a button, or a sensor) that receives input from the outside. Output apparatus 1006 is an output device (for example, a display, a speaker, or an LED lamp) which makes outputs to the outside. Note that input apparatus 1005 and output apparatus 1006 may be integrated (for example, a touchscreen).

The apparatuses, such as processor 1001, memory 1002, and the like are connected by bus 1007 for communication of information. Bus 1007 may be configured using a single bus or using buses different between each pair of the apparatuses.

Furthermore, CU 10, BBU 20, and UE 40 may include hardware, such as a microprocessor, a digital signal processor (DSP), an Application Specific Integrated Circuit (ASIC), a Programmable Logic Device (PLD), and a Field Programmable Gate Array (FPGA), and the hardware may implement part or all of the functional blocks. For example, processor 1001 may be implemented using at least one of these pieces of hardware.

(Notification of Information and Signaling)

The notification of information is not limited to the aspects or embodiments described in the present disclosure, and the information may be notified by another method. For example, the notification of information may be carried out by one or a combination of physical layer signaling (for example, Downlink Control Information (DCI) and Uplink Control Information (UCI)), higher layer signaling (for example, Radio Resource Control (RRC) signaling, Medium Access Control (MAC) signaling, broadcast information (Master Information Block (MIB) and System Information Block (SIB))), and other signals. The RRC signaling may be called an RRC message and may be, for example, an RRC connection setup message, an RRC connection reconfiguration message, or the like.

(Applied System)

The aspects and embodiments described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least one of LTE and LTE-A and 5G) may be applied.

(Processing Procedure and the Like)

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

(Operation of Base Station)

Specific operations which are described in the present disclosure as being performed by the base station may sometimes be performed by an upper node depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (for example, MME and S-GW).

(Direction of Input and Output)

The information or the like (see the item of “Information and Signals”) can be output from a higher layer (or a lower layer) to a lower layer (or a higher layer). The information, the signals, and the like may be input and output through a plurality of network nodes.

(Handling of Input and Output Information and the Like)

The input and output information and the like may be saved in a specific place (for example, memory) or may be managed using a management table. The input and output information and the like can be overwritten, updated, or additionally written. The output information and the like may be deleted. The input information and the like may be transmitted to another apparatus.

(Determination Method)

The determination may be made based on a value expressed by one bit (0 or 1), based on a Boolean value (true or false), or based on comparison with a numerical value (for example, comparison with a predetermined value).

(Software)

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a web site, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

(Information and Signals)

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

(“System” and “Network”)

The terms “system” and “network” used in the present disclosure can be interchangeably used.

(Names of Parameters and Channels)

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (for example, PUCCH and PDCCH) and information elements can be identified by any suitable names, and various names assigned to these various channels and information elements are not limitative in any respect.

(Base Station (Radio Base Station))

The terms “Base Station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like may be used interchangeably in the present disclosure. The base station may be called a macro cell, a small cell, a femtocell, or a pico cell.

The base station can accommodate one cell or a plurality of (for example, three) cells. When the base station accommodates a plurality of cells, the entire coverage area of the base station can be divided into a plurality of smaller areas, and each of the smaller areas can provide a communication service based on a base station subsystem (for example, small base station for indoor remote radio head (RRH)). The term “cell” or “sector” denotes part or all of the coverage area of at least one of the base station and the base station subsystem that perform the communication service in the coverage.

(Terminal)

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

(Base Station/Mobile Station)

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user terminal. For example, the aspects and the embodiments of the present disclosure may find application in a configuration that results from replacing communication between the base station and the user terminal with communication between multiple user terminals (such communication may, e.g., be referred to as device-to-device (D2D), vehicle-to-everything (V2X), or the like). The wordings “uplink” and “downlink” may be replaced with a corresponding wording for inter-equipment communication (for example, “sidelink”). For example, an uplink channel, a downlink channel, and the like may be replaced with a sidelink channel.

Similarly, the terminal in the present disclosure may be replaced with the base station. In this case, the base station is configured to have the functions that the terminal has.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

The reference signal can also be abbreviated as an RS and may also be called as a pilot depending on the applied standard.

The description “based on” used in the present disclosure does not mean “based only on,” unless otherwise specified. In other words, the description “based on” means both of “based only on” and “based at least on.”

Any reference to elements by using the terms “first,” “second,” and the like does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

The “section” in the configuration of each apparatus may be replaced with “means,” “circuit,” “device,” or the like.

In a case where terms “include,” “including,” and their modifications are used in the present disclosure, these terms are intended to be inclusive like the term “comprising.” Further, the term “or” used in the present disclosure is not intended to be an exclusive or.

The radio frame may be constituted by one frame or a plurality of frames in time domain. The one frame or each of the plurality of frames may be called a subframe in time domain. The subframe may be further constituted by one slot or a plurality of slots in time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SC S), a bandwidth, a symbol length, a cyclic prefix length, Transmission Time Interval (TTI), the number of symbols per TTI, a radio frame configuration, specific filtering processing that is performed by a transmission and reception apparatus in frequency domain, specific windowing processing that is performed by a transmission and reception apparatus in time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in time domain. The slot may also be a time unit based on the numerology.

The slot may include a plurality of mini-slots. Each of the mini-slots may be constituted by one or more symbols in time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (for example, 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that can be used in each user terminal) on a TTI-by-TTI basis to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in time domain and frequency domain, and may include one or more contiguous subcarriers in frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RBs) for a certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

In a case where articles, such as “a,” “an,” and “the” in English, for example, are added in the present disclosure by translation, nouns following these articles may have the same meaning as used in the plural.

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### Variations and the Like of Aspects

The aspects and embodiments described in the present disclosure may be independently used, may be used in combination, or may be switched and used along the performance. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

The present patent application claims the benefit of priority based on Japanese Patent Application No. 2020-058845 filed on Mar. 27, 2020, and the entire contents of Japanese Patent Application No. 2020-058845 are incorporated herein by reference.

### INDUSTRIAL APPLICABILITY

One aspect of the present disclosure is useful, for example, for radio communication systems.

### REFERENCE SIGNS LIST

1 Radio communication system
10 Central unit (CU)
20 Baseband unit (BBU)
30 Radio unit (RU)
40 Terminal (UE)
101 Reception section (combination section)
102 Demodulation section
103 Determination section
104 Control section
201 Reception section
202 Quantization section
203 Demodulation section
204 Determination section
205 Transmission section
206 Control section
211,212 Switch (SW)
401 Transmission signal generation section
402 Encoding/modulation section
403 DA conversion section
404 Transmission section
405 Antenna
411 Reception section
412 AD conversion section
413 Decoding/demodulation section
414 Control section

1. A communication apparatus, comprising:
a reception section that receives an uplink signal;
a control section that determines at least one signal process to be applied to the uplink signal, among a plurality of signal processes for the uplink signal; and
a transmission section that transmits, to a backhaul, an uplink signal which has been subjected to the determined at least one signal process.

2. The communication apparatus according to claim 1, wherein:
the plurality of signal processes includes a first process for quantizing the uplink signal, a second process for demodulating the quantized uplink signal, and a third process for determining the demodulated uplink signal; and
the control section determines to apply the first process to the uplink signal, to apply the first process and the second process to the uplink signal, or to apply the first process, the second process, and the third process to the uplink signal.

3. The communication apparatus according to claim 2, wherein the control section determines to apply the first process, the second process, and the third process to the uplink signal, in a case where the uplink signal is not a signal that is a target of reception in coordination with another communication apparatus different from the communication apparatus.

4. The communication apparatus according to claim 2, wherein the control section determines at least one process to be applied to the uplink signal among the first process, the second process, and the third process, in a case where the uplink signal is a signal that is a target of reception in coordination with another communication apparatus different from the communication apparatus.

5. The communication apparatus according to claim 4, wherein the control section determines to apply the first process, the second process, and the third process to the uplink signal, in a case where a usage rate of a bandwidth of the backhaul exceeds a threshold value.

6. The communication apparatus according to claim 5, wherein the control section determines to apply the first process, or the first process and the second process to the uplink signal, in a case where the usage rate of the bandwidth of the backhaul is not greater than the threshold value.

7. The communication apparatus according to claim 6, wherein the control section controls at least one of a number of quantization bits and a quantization range in the first process, based on information on a quality of the uplink signal.

8. The communication apparatus according to claim 6, wherein the control section controls a number of quantization bits in the second process, based on information on a quality of the uplink signal, in a case where the first process and the second process are applied to the uplink signal.

9. The communication apparatus according to claim 2, wherein the control section determines whether to apply, among a soft determination process and a hard determination process each included in the third process, the hard determination process to the uplink signal, in a case where the third process is applied to the uplink signal.

10. A communication method, comprising:
receiving, by a communication apparatus, an uplink signal;
determining, by the communication apparatus, at least one signal process to be applied to the uplink signal, among a plurality of signal processes for the uplink signal; and
transmitting, by the communication apparatus, to a backhaul, an uplink signal which has been subjected to the determined at least one signal process.

11. The communication apparatus according to claim 7, wherein the control section controls a number of quantization bits in the second process, based on information on a quality of the uplink signal, in a case where the first process and the second process are applied to the uplink signal.
